(19) United States
(12) Patent Application Publication
(10) Pub. No.: US 2002/0189105 A1
(43) Pub. Date: Dec. 19, 2002

(54) Manual safety straight razor having double-sided blades

(76) Inventor: Haruyuki Kitano, Utsunomiya City (JP)

Correspondence Address: WENDEROTH, LIND & PONACK, L.L.P., 2033 K STREET N. W., SUITE 800, WASHINGTON, DC, 20006-1021, US

(21) Appl. No.: 09/983,282

(22) Filed: Oct. 23, 2001

(30) Foreign Application Priority Data
Jun. 19, 2001 (JP) 234215/2001

(51) Int. Cl. B26B 21/10

(52) U.S. Cl. 30/53; 30/50

(57) ABSTRACT

An in-line doubled-sided manual safety straight razor having dual razor-sharp cutting edges which can be easily and safely used both by professionals and at-home users either by pulling and pushing a razor blade edge for precise and safe shaving of hair from the face and other body region whereby a pair of razor blades being mounted detachably and respectively into between the narrow wedge portion and the middle platform structure, and both of the angles of the razor blade strips are so sharpened symmetrically and outwardly that the angle of inclination of the imaginary lines L₁ (20 degrees) linking the razor blade strips and the imaginary L₂ (30 degrees) linking the rounded elongated lower portion and is between 20-30 degrees when the razor blade strips are inclined to fit the razor blade strips on the surface of a skin for safe and easy shaving of hair from the surface of a skin.

### BACKGROUND OF THE INVENTION

1. Field of the Invention

This invention relates to a manual safety straight razor having doubled-sided blades, and more particularly to an in-line double-sided straight razor blade manual safety straight razor having dual razor-sharp cutting edges positioned between front and rear guards which can be easily used both by professionals and at-home users either by pulling or pushing a razor blade strip for precise and safe shaving of hair from the face and other body regions.

2. Description of the Prior Art

There are different kinds of razors, such as for professional, at-home or disposal razors in the market. Since a sharp blade of a razor is used in a direct contact with the skin or a neck to remove hair from the skin, vigilant attention must be given to shaving.

In order to avoid a possible accidental cut, nick or scrape of using a straight razor by the hands of at-home users other than a barber or beautician, the T-bar razors have been widely used and still in use.

Since the advent of blood-infected communicable diseases such as AIDS, the HIV virus, hepatitis and other serious diseases, there is a serious social problem.

Even trained professionals such as barbers or beauticians will from time to time accidentally cut, nick or scrape the skin of their customers with such razors, causing some minor bleeding.

Barbers, beauticians and healthcare workers are reluctant to come into contact with blood from other, and tend to avoid tasks where such contact is likely.

Under the above circumstances, special sterilization is ordered recently for the professional razors used in the barbershops or beauty parlors by a public health center.

In order to avoid an accidental cut, nick or scrape of the skin, not only vigilant attention is requested even for the skilled barber or beautician, but also a safety razor must be proposed.

U.S. Pat. No. 6,164,290 to Edward A. Andrews discloses a double-sided safety straight razor shaving device having dual razor-sharp cutting edges positioned between front and rear guards, and an in-line handle which can easily be gripped for precise shaving of the face and other body surfaces.

This double-sided safety straight razor has four razor strips, which cannot be used both for pull and push shavings.

The Japanese Patent Publication No. 114246/1999 (not examined) discloses a change blade-type razor and a method of shaving hair from the face and other body regions whereby a safe and slant shaving can be easily carried out even by an unskilled user.

The Japanese Patent Publication No. 277369/1994 (not examined) shows a wet-type razor device 1 which comprises a long handle portion 2, a shaving portion 3 mounted to the long handle portion 2 by fixing parts 9 and 26 whereby a shaving hair from the face and other body regions.

The Japanese Utility Model Publication No. 11674/1994 (not examined) discloses a safety razor having double-sided blades which comprises a handle portion 1, an elongated front cutter portion 2, and a pair of razor blades 7 and 8 provided at both side portions of the front cutter portion 2 to locate both back portions 7b and 8b at both side portions of a back portion 2b of the front cutter portion 2, which is characterized in that a plane Q linking the belly 2a of the front cutter portion 2 extending to the back portion 2b including a pair of razor blades strips 7a and 8a and a plane R linking the razor blades strips 7a and 8 and the back portions 7b and 8b are substantially in parallel with each other, or a space S between the planes Q and R are narrowed gradually from the back portion 2a of the front cutter portion 2 into the belly 2a.

The razor shown in the Japanese Utility Model Publication No. 104770/1987 (not examined) has a handle portion 1, a pair of connecting portions 2 and 2, a pair of support portions 3 and 3, a pair of blade strips 4 and 4 held into the support portions 3 and 3, a sponge 5 inserted into between the blade strips 4 and 4 and the support portions 3 and 3.

The razor holder described in the Japanese Utility Model Publication No. 46673/1994 (not examined) includes a handle portion 1 having a holder 1b, which comprises a groove 3 whereby a razor blade strip can be easily made.

The in-line doubled-sided manual safety straight razor of this invention is based on my experience as a barber over the long years and my experience that an angle of inclination of the line linking a bottom portion of a blade edge of a razor and a rounded elongated lower portion of a top elongated wide complementary head portion must take the angle between 20-30 degrees.

It should be understood that in case the angle of inclination of the line linking a blade edge of a razor and a rounded elongated lower portion of a top elongated wide complementary head portion is below 20 degrees, a shaving angle of the blade edge of hair is made dull into a scraping angle, thus causing insufficient shaving of facial hair, and in case the inclination angle is over 30 degrees, the blade edge is made into a sharp edge to cut the skin accidentally.

### SUMMARY OF THE INVENTION

A primary object of this invention is to provide a manual safety razor having double-sided blades that can be easily used both by professionals and at-home users either by pulling or pushing the razor blade strips of the manual safety razor for easy, precise and safe shaving of hair from the face and other body regions.

Another object of this invention is to provide a manual safety razor having double-sided blades whereby an accidental cut, nick or scrape of the skin can be avoided to prevent infection of blood-infected communicable diseases such as AIDS, the HIV virus, hepatitis and other serious diseases.

Another object of this invention is to provide a manual safety razor having double-sided blades whereby both angles of inclination of lines linking the razor blade strips of the manual safety razor and a rounded elongated lower member portion is between 20-30 degrees in order to fit the razor blade strips on the surface of a skin with a given shallow and safe angle of inclination for shaving.

Another object of this invention is to provide a manual safety razor having double-sided blades whereby both of the angles of inclination of lines linking the razor blade strips of the razor blades and a rounded elongated lower member portion of the razor structure is between 20-30 degrees in order to enable a user either to pull or push the razor blade strips on the surface of a skin.

Another object of this invention is to provide a manual safety razor having double-sided blades which can be easily used both by professionals and at-home users either by pulling or pushing a razor blade strip for precise and safe shaving hair from the face and other body regions.

Another object of this invention is to provide a manual safety razor having double-sided blades which can be easily pulled or pushed by a wrist's motion of a user.

Another object of this invention is to provide a manual safety razor having double-sided blades whereby a correct angle of inclination of a pair of razor blades can be easily selected to a face or other body regions.

Another object of this invention is to provide a manual safety razor having double-sided blades, which is simple in construction, so that it can be made easily.

Still another object of this invention is to provide a manual safety razor having double-sided blades whereby many individuals prefer to use the professional services of a barber or beautician of a facial shaving without anxiety.

### BRIEF DESCRIPTION OF THE DRAWINGS

This object and features of the invention will become apparent from the following description taken in conjunction with the preferred embodiment thereof with reference to the accompanying drawings, in which:

### BRIEF DESCRIPTION OF THE DRAWINGS

This object and features of the invention will become apparent from the following description taken in conjunction with the preferred embodiment thereof with reference to the accompanying drawings, in which:

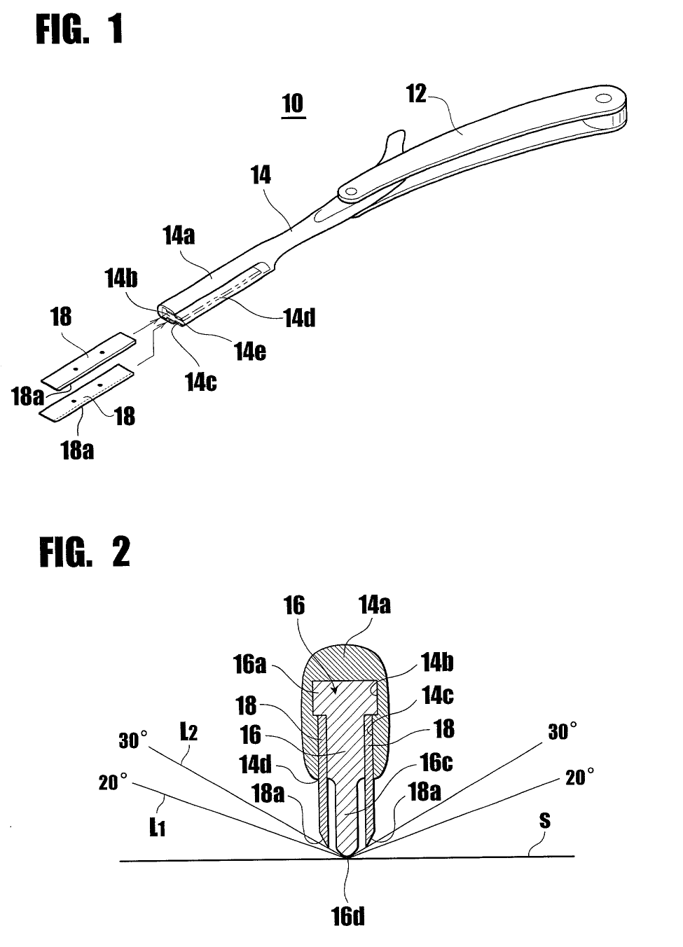

FIG. 1 is a perspective view schematically showing that a pair of razor blade strips is being mounted into an elongated front handle portion of a manual safety razor of this invention.

FIG. 2 is an enlarged schematic longitudinal sectional view of a manual safety razor shown in FIG. 1.

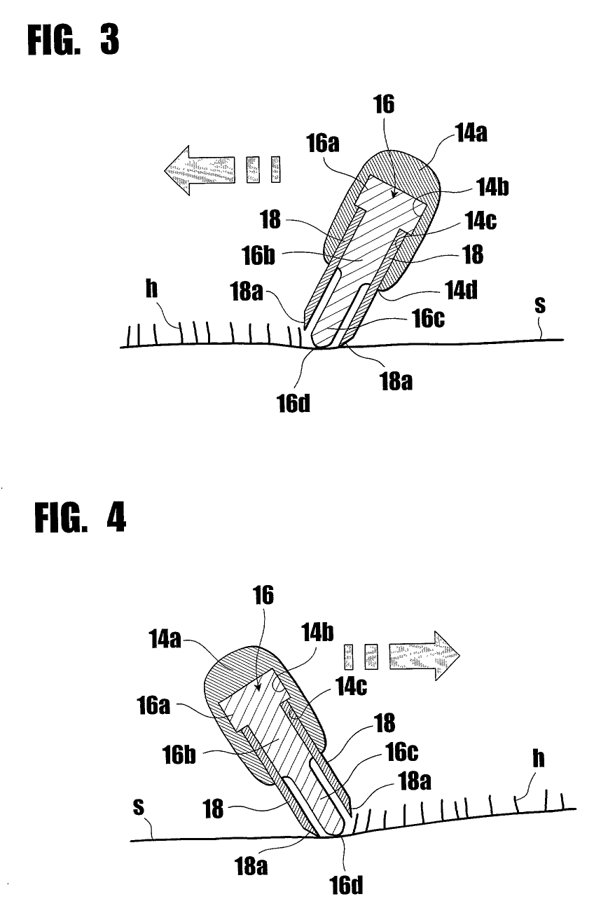

FIG. 3 is an enlarged schematic longitudinal sectional view of a manual safety razor shown in FIGS. 1 and 2 showing that one of the razor blade strip is being pulled to shave hair; and

FIG. 4 is a similar enlarged schematic longitudinal sectional view of a manual safety razor shown in FIGS. 3 showing that another razor blade strip is being pushed to shave hair.

### DESCRIPTION OF THE PREFERRED EMBODIMENTS

Referring now to the drawings, a manual safety razor 10 having double-sided blades comprises an elongated rear handle portion 12 and an elongated front handle portion 14 which is pivotally secured to a front portion of the elongated rear handle portion 12.

As particularly shown in FIG. 3, the elongated front handle portion 14 has a longitudinal cutter head portion 14a including an elongated wide complementary opening 14b and a pair of middle staged tenons 14c, 14c which are spaced from each other to form a narrow wedge portion 14d.

A razor structure 16 has a top elongated wide complementary head portion 16a interlocking into the elongated wide complementary opening 14b, a middle platform structure 16b extending from the top elongated wide complementary head portion 16a, the middle platform structure 16b being a little narrower than the top elongated wide complementary head portion 16a, and a rounded elongated lower portion 16d.

As shown in FIGS. 2-4, a pair of razor blades 18, 18 are mounted detachably and respectively into between the narrow wedge portion 14 and the middle platform structure 16b of the razor structure 16, and a razor blade strip 18a of the razor blade 18 is so sharpened to form an outer inclined flat cutting blade portion.

Accordingly, when a pair of the razor blades 18, 18 are mounted into between the narrow wedge portion 14 and the middle platform structure 16b, the razor blades 18, 18 are so arranged to direct the outer inclined flat cutting blade portions of the razor blade strips 18a, 18a symmetrically and outwardly to form an imaginary V-shaped working plane.

To this end, an imaginary line L₁ (20 degrees) linking the rounded elongated lower portion 16d and the razor blade strip 18a when the manual safety razor 10 is inclined to fit the razor blade strip 18a to the surface of a skin s, and an imaginary line L₂ (30 degrees) linking the rounded elongated lower portion 16d and the razor blade strip 18a when the manual safety razor 10 is not inclined.

It should be appreciated that the rounded elongated lower portion 16d is between 20-30 degrees when the manual safety razor 10 is inclined to fit the razor blade strips 18a, 18a on the surface of a skin s.

In practice, the rounded elongated lower portion 16d of the razor structure 16 is put on the skin s vertically, and subsequently the narrow wedge portion 14 is inclined to touch an edge portion of the razor blade 18 on the surface of the skin s to take a proper angle of inclination between 20-30 degrees.

In view of the fact that both the angles of inclination of lines linking the razor blade strip 18a, 18a of the razor blades 18, 18 and the rounded elongated lower portion 16d are selected to an angle between 20-30 degrees, the razor blades 18, 18 are fitted softly at a suitable angle to the surface of the skin s so that easy, safe and reliable shaving of hair h from the surface of the skin s can be carried out not only by the barber and beautician, but also by an unskilled user.

Accordingly, the desired angles of inclination of the razor blade strips 18a, 18a can be easily adjusted to take an obtuse angle between 20-30 degrees to the surface of the skin s, thus enabling to shave the hair h from the face and other body regions softly, safely and reliably without causing an accidental cut, nick or scrape of the skin s.

At the same time, both of pulling and pushing motions of the inclined outer face of the razor blade strips 18a, 18a can be carried out easily and freely by a wrist's motion of a user.

It is to be understood that the in-line safety straight razor of this invention is by no means limited to the particular construction and uses herein described, disclosed and/or shown in the drawing.

It is understood that modifications to the invention as described may be made, as might occur to one with skill in the field of the invention, within the scoped of the appended claims. All embodiments contemplated hereunder, which achieve the objects of the invention, have therefore not been shown in complete detail.

Other embodiments may be developed without departing from the spirit of the invention or from the scope of the appended claims.

What I claim

1. A manual safety straight razor having double-sided blades which comprises:
an elongated rear handle portion and an elongated front handle portion, said front handle portion having its rear portion pivotally secured to a front portion of said elongated rear handle portion;
said elongated front handle portion having a longitudinal cutter head portion including an elongated wide complementary opening and a pair of middle staged tenon spaced from each other to form a narrow wedge portion;
a razor structure having a top elongated wide complementary head portion interlocking into said elongated wide complementary opening, a middle platform structure extending from said top elongated wide complementary head portion, said platform structure being a little narrower than said top elongated wide complementary head portion, and a rounded elongated lower member portion; and
a pair of razor blades respectively and detachably mounted into between said narrow wedge portion and said middle platform structure;
which is characterized in that when a pair of the razor blades are mounted into between the narrow wedge portion and the middle platform structure, the razor blades are so arranged to direct the inclined flat cutting blade portions of the razor blade strips symmetrically and outwardly to form an imaginary V-shaped working plane, and that the angle of inclination of lines linking edges of the razor blade strips and said rounded elongated lower member portion of said razor structure is between 20-30 degrees when the razor blade strips are fitted to the surface of a skin.

2. A manual safety straight razor having double-sided blades as claimed in claim 1, which comprises a pair of the razor blades mounted into between the narrow wedge portion and the middle platform structure, and both of the razor blade strips being so arranged to form an imaginary V-shaped working plane.

3. A manual safety straight razor having double-sided blades as claimed in claim 1, which is characterized in that the razor blades being spaced from and parallel to the said razor structure.
